(19) United States
(12) Patent Application Publication
(10) Pub. No.: US 2024/0267930 A1
(43) Pub. Date: Aug. 8, 2024

(54) PERFORMING DOWNLINK CHANNEL MONITORING ON CELLS BASED ON DISCONTINUOUS RECEPTION STATES

(71) Applicant: QUALCOMM Incorporated, San Diego, CA (US)

(72) Inventors: Kazuki TAKEDA, Minato-ku (JP); Jelena DAMNJANOVIC, Del Mar, CA (US); Tao LUO, San Diego, CA (US)

(21) Appl. No.: 18/359,290

(22) Filed: Jul. 26, 2023

Related U.S. Application Data
(60) Provisional application No. 63/483,722, filed on Feb. 7, 2023.

(51) Int. Cl. H04W 72/232; H04W 72/1263; H04W 76/28

(52) U.S. Cl. CPC H04W 72/232; H04W 72/1263; H04W 76/28

(57) ABSTRACT

Various aspects of the present disclosure generally relate to wireless communication. In some aspects, a user equipment (UE) may receive, from a network node, a configuration associated with cell scheduling. The UE may perform and based at least in part on the configuration and for a cell scheduling of a second cell, a physical downlink control channel (PDCCH) monitoring on a first cell or on the second cell based at least in part on one or more of a discontinuous reception (DRX) state of a first DRX group associated with the first cell or a DRX state of a second DRX group associated with the second cell. Numerous other aspects are described.

### CROSS-REFERENCE TO RELATED APPLICATION

This Patent Application claims priority to U.S. Provisional Patent Application No. 63/483,722, filed on Feb. 7, 2023, entitled “PERFORMING DOWNLINK CHANNEL MONITORING ON CELLS BASED ON DISCONTINUOUS RECEPTION STATES,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for performing downlink channel monitoring on cells based at least in part on discontinuous reception (DRX) states.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a user equipment (UE) includes a memory and one or more processors, coupled to the memory, that, based at least in part on information stored in the memory, are configured to: receive, from a network node, a configuration associated with cell scheduling; and perform, based at least in part on the configuration and for a cell scheduling of a second cell, a physical downlink control channel (PDCCH) monitoring on a first cell or on the second cell based at least in part on one or more of a discontinuous reception (DRX) state of a first DRX group associated with the first cell or a DRX state of a second DRX group associated with the second cell.

In some implementations, an apparatus for wireless communication at a network node includes a memory and one or more processors, coupled to the memory, configured to: transmit, to a UE, a configuration associated with cell scheduling; and transmit, to the UE and based at least in part on the configuration, DCI associated with a cell scheduling for a second cell, a PDCCH monitoring on a first cell or on the second cell being based at least in part on one or more of a DRX state of a first DRX group associated with the first cell or a DRX state of a second DRX group associated with the second cell.

In some implementations, a method of wireless communication performed by a UE includes receiving, by the UE and from a network node, a configuration associated with cell scheduling; and performing, by the UE, and based at least in part on the configuration and for a cell scheduling of a second cell, a PDCCH monitoring on a first cell or on the second cell being based at least in part on one or more of a DRX state of a first DRX group associated with the first cell or a DRX state of a second DRX group associated with the second cell.

In some implementations, a method of wireless communication performed by a network node includes transmitting, by the network node and to a UE, a configuration associated with cell scheduling; and transmitting, by the network node and to the UE and based at least in part on the configuration, DCI associated with a cell scheduling for a second cell, a PDCCH monitoring on a first cell or on the second cell being based at least in part on one or more of a DRX state of a first DRX group associated with the first cell or a DRX state of a second DRX group associated with the second cell.

In some implementations, a non-transitory computer-readable medium storing a set of instructions for wireless communication includes one or more instructions that, when executed by one or more processors of a UE, cause the UE to: receive, from a network node, a configuration associated with cell scheduling; and perform and based at least in part on the configuration and for a cell scheduling of a second cell, a PDCCH monitoring on a first cell or on the second cell being based at least in part on one or more of a DRX state of a first DRX group associated with the first cell or a DRX state of a second DRX group associated with the second cell.

In some implementations, a non-transitory computer-readable medium storing a set of instructions for wireless communication includes one or more instructions that, when executed by one or more processors of a network node, cause the network node to: transmit, to a UE, a configuration associated with cell scheduling; and transmit, to the UE and based at least in part on the configuration, DCI associated with a cell scheduling for a second cell, a PDCCH monitoring on a first cell or on the second cell being based at least in part on one or more of a DRX state of a first DRX group associated with the first cell or a DRX state of a second DRX group associated with the second cell.

In some implementations, an apparatus for wireless communication includes means for receiving, from a network node, a configuration associated with cell scheduling; and means for performing and based at least in part on the configuration and for a cell scheduling of a second cell, a PDCCH monitoring on a first cell or on the second cell being based at least in part on one or more of a DRX state of a first DRX group associated with the first cell or a DRX state of a second DRX group associated with the second cell.

In some implementations, an apparatus for wireless communication includes means for transmitting, to a UE, a configuration associated with cell scheduling; and means for transmitting, to the UE and based at least in part on the configuration, DCI associated with a cell scheduling for a second cell, a PDCCH monitoring on a first cell or on the second cell being based at least in part on one or more of a DRX state of a first DRX group associated with the first cell or a DRX state of a second DRX group associated with the second cell.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a discontinuous reception (DRX) operation, in accordance with the present disclosure.

FIG. 5 is a diagram illustrating an example of DRX groups, in accordance with the present disclosure.

FIG. 6 is a diagram illustrating an example of a cross-carrier scheduling or a multi-carrier scheduling, in accordance with the present disclosure.

FIGS. 7-8 are diagrams illustrating examples associated with performing downlink channel monitoring on cells based at least in part on DRX states, in accordance with the present disclosure.

FIGS. 9-10 are diagrams illustrating example processes associated with performing downlink channel monitoring on cells based at least in part on DRX states, in accordance with the present disclosure.

FIGS. 11-12 are diagrams of example apparatuses for wireless communication, in accordance with the present disclosure.

### DETAILED DESCRIPTION

Various aspects of the disclosure are described more fully hereinafter with reference to the accompanying drawings. This disclosure may however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

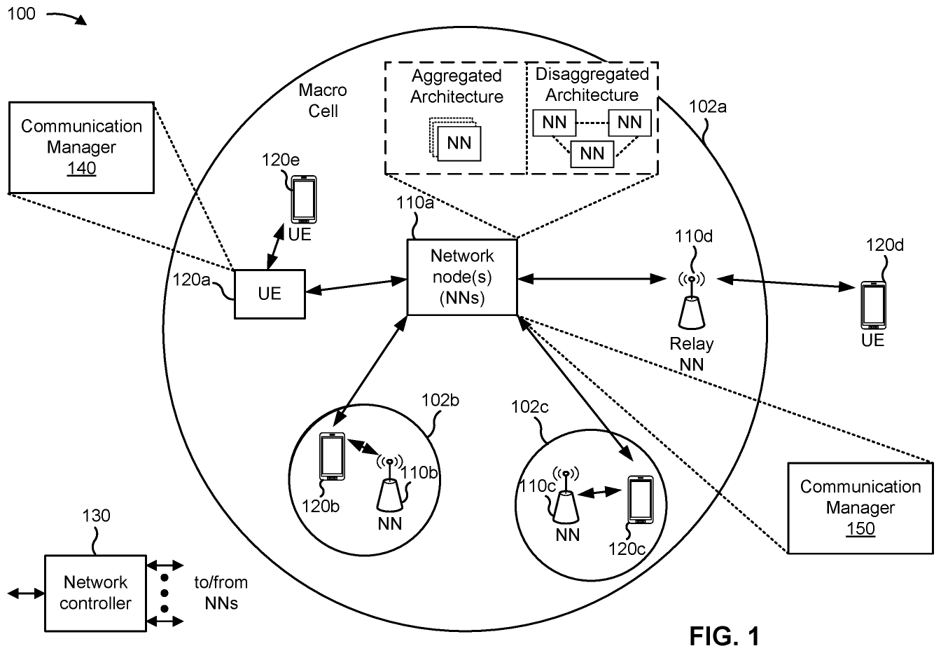

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., UE 120) may include a communication manager 140. As described in more detail elsewhere herein, the communication manager 140 may receive, from a network node, a configuration associated with cell scheduling; and perform and based at least in part on the configuration and for a cell scheduling of a second cell, a physical downlink control channel (PDCCH) monitoring on a first cell or on the second cell based at least in part on one or more of a discontinuous reception (DRX) state of a first DRX group associated with the first cell or a DRX state of a second DRX group associated with the second cell. Additionally, or alternatively, the communication manager 140 may perform one or more other operations described herein.

In some aspects, a network node (e.g., network node 110) may include a communication manager 150. As described in more detail elsewhere herein, the communication manager 150 may transmit, to a UE, a configuration associated with cell scheduling; and transmit, to the UE and based at least in part on the configuration, downlink control information (DCI) associated with a cell scheduling for a second cell, a PDCCH monitoring on a first cell or on the second cell being based at least in part on one or more of a DRX state of a first DRX group associated with the first cell or a DRX state of a second DRX group associated with the second cell. Additionally, or alternatively, the communication manager 150 may perform one or more other operations described herein.

As indicated above, FIG. 1 is provided as an example. Other examples may differ from what is described with regard to FIG. 1.

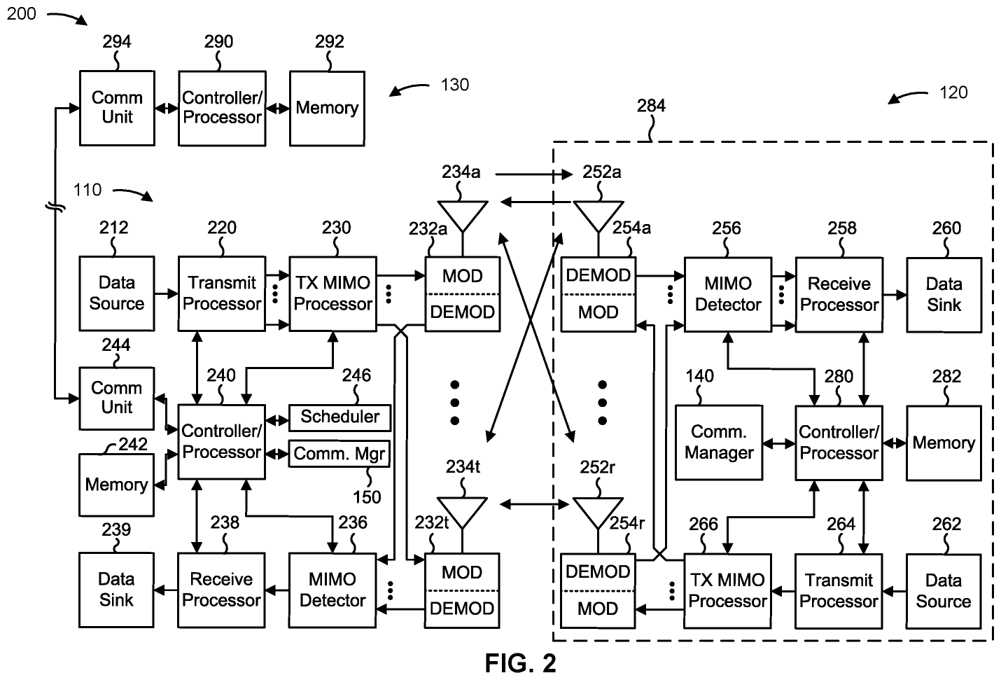

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

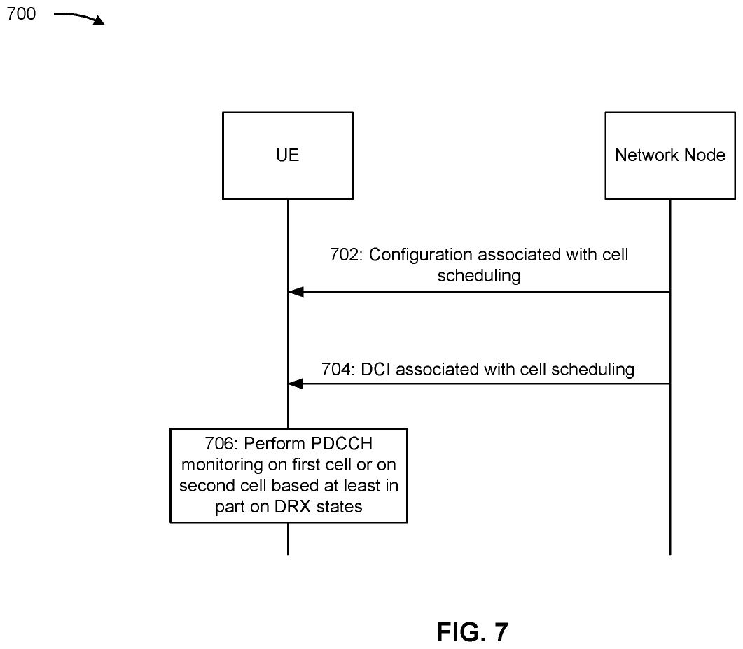

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-12).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-12).

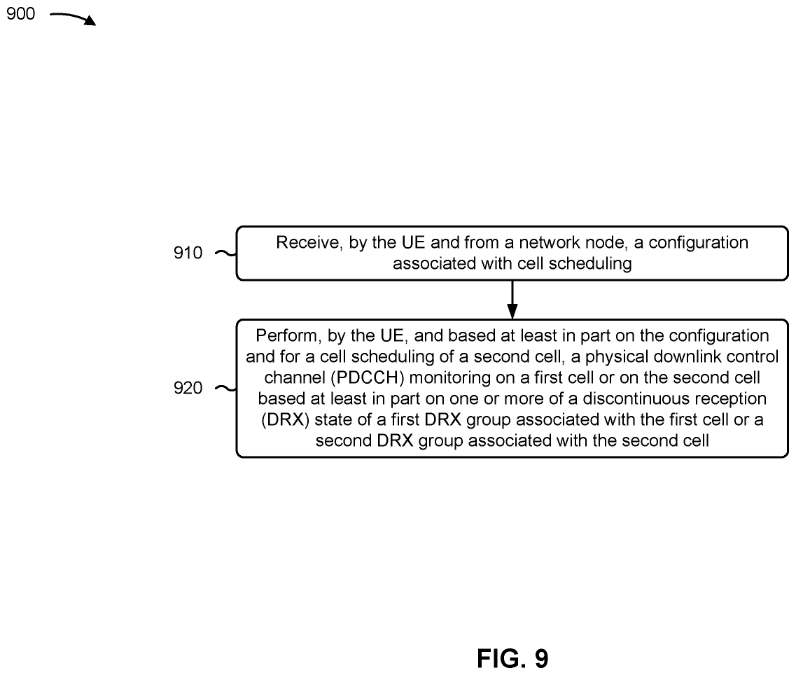

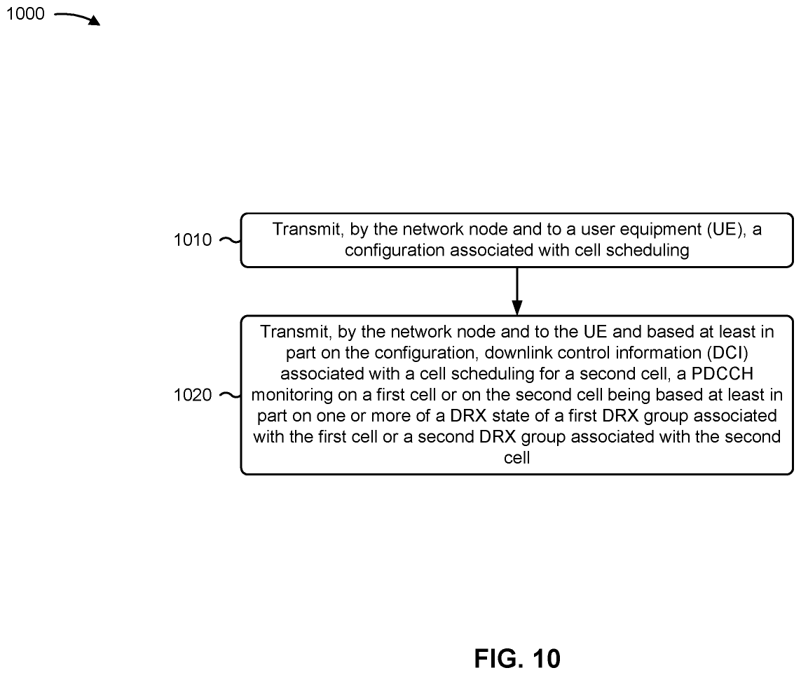

The controller/processor 240 of the network node 110, the controller/processor 280 of the UE 120, and/or any other component(s) of FIG. 2 may perform one or more techniques associated with performing downlink channel monitoring on cells based at least in part on DRX states, as described in more detail elsewhere herein. For example, the controller/processor 240 of the network node 110, the controller/processor 280 of the UE 120, and/or any other component(s) of FIG. 2 may perform or direct operations of, for example, process 900 of FIG. 9, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, a UE (e.g., the UE 120) includes means for receiving, by the UE and from a network node, a configuration associated with cell scheduling; and/or means for performing, by the UE, and based at least in part on the configuration and for a cell scheduling of a second cell, a PDCCH monitoring on a first cell or on the second cell being based at least in part on one or more of a DRX state of a first DRX group associated with the first cell or a DRX state of a second DRX group associated with the second cell. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for transmitting, by the network node and to a UE, a configuration associated with cell scheduling; and/or means for transmitting, by the network node and to the UE and based at least in part on the configuration, DCI associated with a cell scheduling for a second cell, a PDCCH monitoring on a first cell or on the second cell being based at least in part on one or more of a DRX state of a first DRX group associated with the first cell or a DRX state of a second DRX group associated with the second cell. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

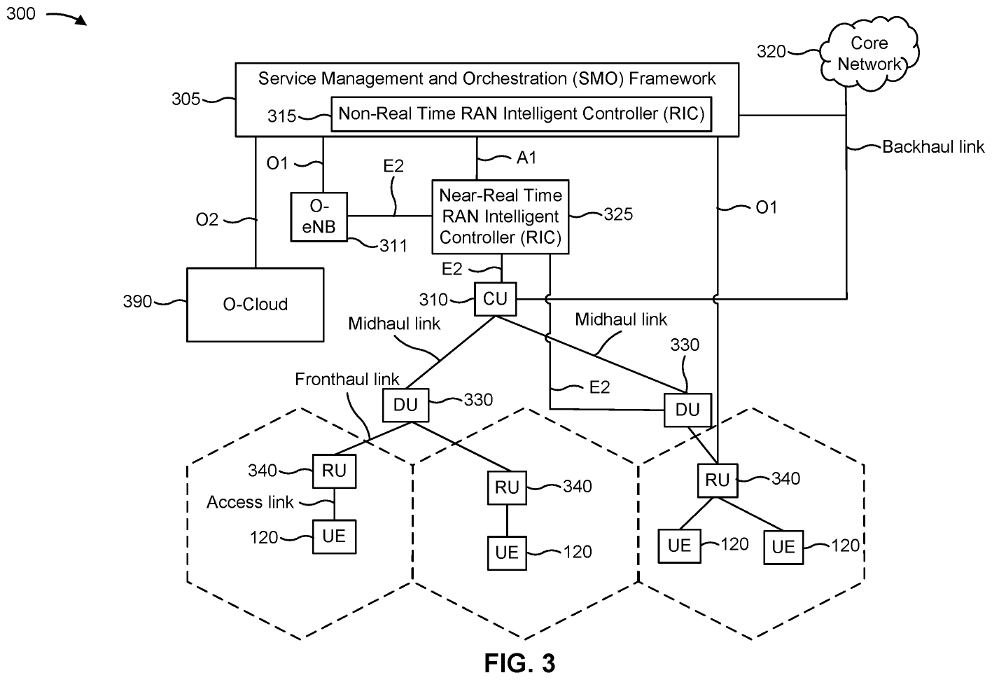

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

An NR system may support a DRX operation. A DRX operation may include an idle mode DRX and a connected mode DRX. In idle mode DRX, a UE may periodically wake up from a sleep mode (e.g., a low power mode) to monitor for paging messages, and the UE may subsequently return to the sleep mode when no paging message is intended for the UE. In connected mode DRX, the UE may periodically enter the sleep mode (off duration), during which the UE does not need to monitor a downlink control channel. In order to monitor the downlink control channel for possible downlink/uplink data, the UE may wake up periodically and stay awake (on duration) for a certain amount of time before returning back to the sleep mode. Connected mode DRX may allow the UE to reduce power consumption because the UE does not need to continuously monitor the downlink control channel.

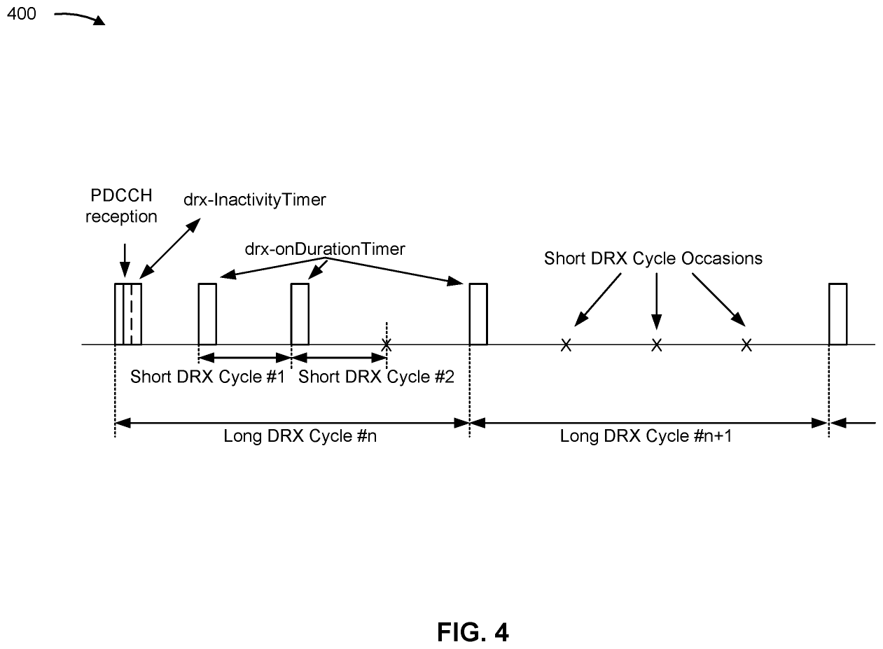

FIG. 4 is a diagram illustrating an example 400 of a DRX operation, in accordance with the present disclosure.

A UE may employ a DRX operation, which may include one or more short DRX cycles and/or one or more long DRX cycles. A long DRX cycle may include an on period (on duration) and an off period. The on period may be a time period (in ms) during which the UE stays awake and decodes a downlink control channel. After the long DRX cycle starts, the UE may stay active for a duration of a DRX on duration timer, and when no downlink control channel transmission is received during this time, the UE may enter the off period, which may correspond to a DRX sleep state. A short DRX cycle may have a shorter time duration, as compared to the long DRX cycle. When the on period of the long DRX cycle has no data activity, the UE may follow the long DRX cycle as if no short DRX cycle is configured. When the on period of the long DRX cycle does have data activity, the UE may switch to the short DRX cycle. When no data activity exists during the short DRX cycle, the UE may then switch to the long DRX cycle.

As shown in FIG. 4, during a long DRX cycle (e.g., long DRX cycle #n, which may be 320 ms in duration), a PDCCH reception may occur at the UE. The UE may start a DRX inactivity timer each time the UE successfully decodes a PDCCH, which may specify a time period for which the UE should be active after successfully decoding the PDCCH. After the long DRX cycle starts, the UE may stay active for a duration of a DRX on duration timer. The UE may switch to short DRX cycles (e.g., short DRX cycle #1 and short DRX cycle #2, which may each be 80 ms in duration) due to data activity. A next long DRX cycle (e.g., long DRX cycle #n+1) may be associated with multiple short DRX cycle occasions with no data activity.

As indicated above, FIG. 4 is provided as an example. Other examples may differ from what is described with regard to FIG. 4.

A DRX group is a group of serving cells, configured via RRC signaling, which have the same DRX active time. The serving cells may be configured via RRC signaling in two DRX groups with separate DRX parameters. For a given entity, a UE may be configured with the two DRX groups. Each serving cell in the MAC entity may belong to either of the two DRX groups. The two DRX groups may be associated with a carrier aggregation operation. When a secondary DRX group is not configured, only one DRX group may be present and all serving cells may be associated with that one DRX group. When two DRX groups are configured, each serving cell may be uniquely assigned to either of the two DRX groups. Some DRX parameters may be separately configured for each DRX group. For example, the two DRX groups may have separate or independent configurations of a DRX on duration timer (drx-onDurationTimer) and a DRX inactivity timer (drx-InactivityTimer). Some DRX parameters may be common to the DRX groups. For example, the two DRX groups may have common configurations of a DRX slot offset (drx-SlotOffset), a DRX retransmission timer for downlink ((drx-RetransmissionTimerDL), a DRX retransmission timer for uplink (drx-RetransmissionTimerUL), a DRX long cycle start offset (drx-LongCycleStartOffset), a DRX short cycle (drx-ShortCycle), a DRX short cycle timer (drx-ShortCycleTimer), a DRX hybrid automatic repeat request (HARQ) round-trip-time (RTT) timer for downlink (drx-HARQ-RTT-TimerDL), a DRX HARQ RTT timer for uplink (drx-HARQ-RTT-TimerUL), and an uplink HARQ mode (uplinkHARQ-Mode). Between the two DRX groups, both DRX groups may be in active time, one of the two DRX groups may be in active time, or neither of the two DRX groups may be in active time.

When a DRX group is in active time, the UE may monitor a PDCCH on serving cells associated with the DRX group. When the PDCCH indicates a downlink transmission, a one-shot HARQ feedback, or a retransmission of HARQ feedback, the UE may start or restart the drx-HARQ-RTT-TimerDL, and the UE may stop the drx-RetransmissionTimerDL. When the PDCCH indicates an uplink transmission, the UE may start or restart the drx-HARQ-RTT-TimerUL, and the UE may stop the drx-RetransmissionTimerUL. When the PDCCH indicates a new transmission (e.g., a downlink transmission or an uplink transmission) on a serving cell of the DRX group, the UE may start or restart the drx-InactivityTimer for the DRX group.

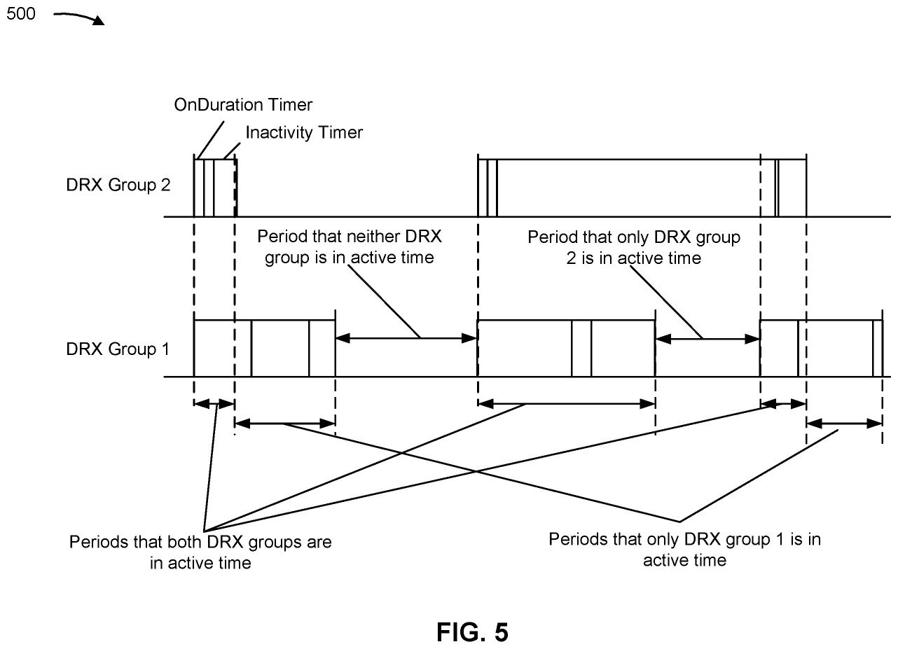

FIG. 5 is a diagram illustrating an example 500 of two DRX groups, in accordance with the present disclosure.

As shown in FIG. 5, a first DRX group may be associated with time periods of active time and time periods of inactive time. A second DRX group may be associated with time periods of active time and time periods of inactive time. During some time periods, both DRX groups may be in active time. During some time periods, only the first DRX group may be in active time. During some time periods, only the second DRX group may be in active time. During some time periods, neither of the DRX groups may be in active time. The first DRX group may be independent from the second DRX group. A UE may perform a PDCCH monitoring during active times associated with the first DRX group and during active times associated with the second DRX group (e.g., DRX on periods associated with the first DRX group and the second DRX group.

As indicated above, FIG. 5 is provided as an example. Other examples may differ from what is described with regard to FIG. 5.

An NR system may support cross-carrier or multi-carrier (cross/multi-carrier) scheduling with different numerologies. FR1 and FR2 may be associated with different numerologies (e.g., different subcarrier spacings (SCSs)). An FR1 cell may schedule one or more FR2 cells using cross/multi-carrier scheduling functionalities. A plurality of FR2 cells (or a subset of FR2 cells) may be cross/multi-carrier scheduled from the FR1 cell. In cross-carrier scheduling, a scheduling cell and a scheduled cell may be different. In multi-carrier scheduling, a DCI format may schedule more than one cell in a set of cells. Scheduled cells by the DCI format may be flexible. For example, the DCI format may schedule multiple combinations of cells, or the DCI format may schedule only one cell from the set of cells.

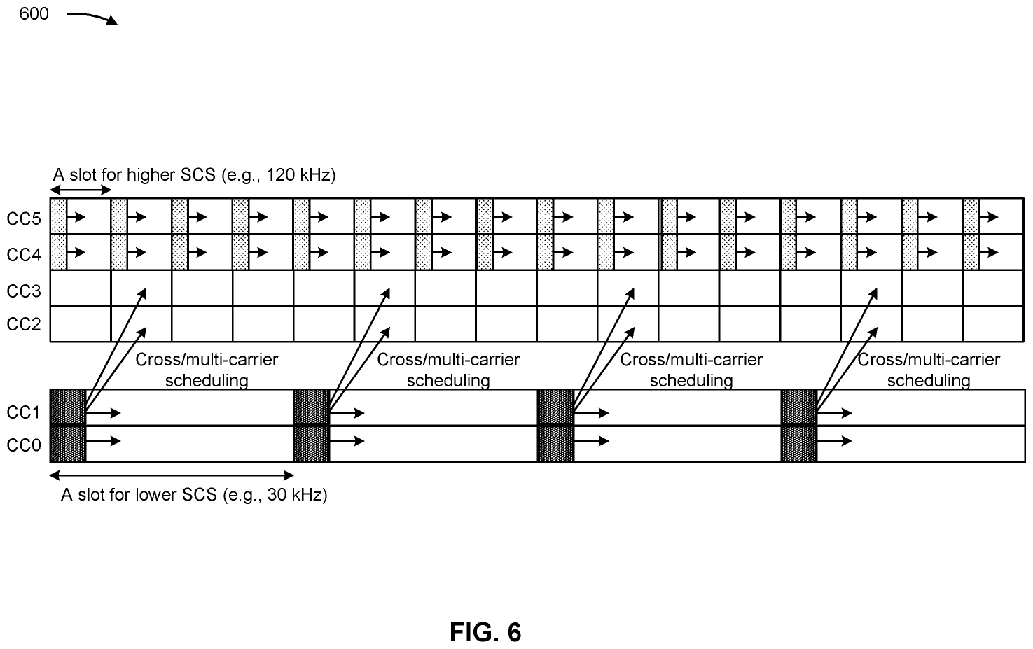

FIG. 6 is a diagram illustrating an example 600 of a cross/multi-carrier scheduling, in accordance with the present disclosure.

As shown in FIG. 6, an FR1 cell may be associated with component carrier 0 (CC0) and component carrier 1 (CC1). An FR2 cell may be associated with component carrier 2 (CC2), component carrier 3 (CC3), component carrier 4 (CC4), and component carrier 5 (CC5). The FR1 cell may be associated with a slot for a lower SCS (e.g., 30 kHz). The FR2 cell may be associated with a slot for a higher SCS (e.g., 120 kHz). In other words, a slot duration for the FR1 cell may be longer than a slot duration for the FR2 cell. For example, the slot duration for the FR1 cell may be four times as long as the slot duration for the FR2 cell (e.g., four FR2 slots may be within one FR1 slot). The FR1 cell may perform a cross/multi-carrier scheduling for the FR2 cell. For example, DCI associated with CC0 and CC1 of the FR1 cell may schedule slots associated with CC2 and CC3 of the FR2 cell. The DCI associated with CC0 and CC1 of the FR1 may also be used to perform a self-scheduling (e.g., a scheduling for CC0 and CC1, respectively). Further, DCI associated with CC4 and CC5 of the FR2 cell may be used to perform a self-scheduling (e.g., a scheduling for CC4 and CC5, respectively).

As indicated above, FIG. 6 is provided as an example. Other examples may differ from what is described with regard to FIG. 6.

A cross/multi-carrier scheduling from an FR1 cell to an FR2 cell may support an FR1-FR2 carrier aggregation. The FR1 cell may be associated with a scheduling cell, and the FR2 cell may be associated with a scheduled cell. The FR1 cell may be associated with an FR1 carrier, and the FR2 cell may be associated with an FR2 carrier. However, the numerology difference between FR1 and FR2 may result in several problems. Since one slot for the FR1 carrier may correspond to multiple slots (e.g., four slots or eight slots) for the FR2 carrier, a slot-level PDCCH monitoring by a UE on the FR1 carrier with one unicast DCI format for the FR2 cell (the scheduled cell) may not achieve a full resource allocation (e.g., a peak data rate may not be achieved). The one unicast DCI format may be unable to schedule multiple slots of the FR2 carrier, due to the numerology difference between FR1 and FR2.

The slot-level PDCCH monitoring on the FR1 carrier may require the processing (e.g., transmission and reception) of multiple DCI formats (e.g., four or eight DCI formats) for scheduling physical downlink shared channels (PDSCHs) or physical uplink shared channels (PUSCHs) on each FR2 carrier at a PDCCH monitoring occasion, which may involve a complicated DCI detection at the UE (as opposed to only one DCI format per PDCCH monitoring occasion). In other words, multiple DCI formats may be used, where each DCI format may be used to schedule a slot of the FR2 carrier (e.g., four DCI formats may be used to schedule four slots of the FR2 carrier, respectively), but such an approach may result in complicated DCI detection at the UE. Further, such an approach may cause a PDCCH resource shortage at the PDCCH monitoring occasion, since the network node may need to transmit a relatively large number of DCI formats within the PDCCH resource, which may not be possible.

Multiple PDCCH monitoring occasions in a slot on the FR1 carrier may allow full resource allocation while keeping only one DCI format per PDCCH monitoring occasion for each FR2 carrier. For example, four different PDCCH monitoring occasions in a slot of the FR1 carrier may allow four slots of the FR2 carrier to be scheduled. However, such an approach may require the UE to monitor the PDCCH more frequently, thereby causing relatively large UE power consumption. For example, when the UE performs a PDCCH monitoring on an entire slot duration of the FR1 carrier, the UE is not permitted to sleep during the entire slot duration, which may prevent power savings at the UE.

In various aspects of techniques and apparatuses described herein, a UE may receive, from a network node, a configuration associated with cell scheduling. The UE may be configured with an FR1 and FR2 carrier aggregation. The UE may be configured with two DRX groups, which may include a first DRX group and a second DRX group. The UE may perform, based at least in part on the configuration and for a cell scheduling of a second cell, a PDCCH monitoring on a first cell or on the second cell based at least in part on one or more of a DRX state of a first DRX group associated with the first cell or a DRX state of a second DRX group associated with the second cell. The first cell may be associated with FR1, and the second cell may be associated with FR2. Alternatively, the first cell and the second cell may be associated with FR1, or the first cell and the second cell may be associated with FR2.

In some aspects, the UE may be configured with the two DRX groups for the FR1 and FR2 carrier aggregation. The first DRX group may be associated with the FR1 cell, which may be an FR1 scheduling cell. The second DRX group may be associated with the FR2 cell, which may be an FR2 scheduled cell. For the FR2 cell, the UE may monitor the PDCCH on the FR1 cell for cross/multi-carrier scheduling, or the UE may monitor the PDCCH on the FR2 cell for self-scheduling, based at least in part on the DRX state of the first DRX group and/or the DRX state of the second DRX group. When the second DRX group is off (e.g., FR2 DRX group is off), the UE may monitor the PDCCH for the FR2 cell on the FR1 cell for cross/multi-carrier scheduling. When the second DRX group is on (e.g., FR2 DRX group is on), the UE may monitor the PDCCH for the FR2 cell on the FR2 cell for self-scheduling. As a result, whether the UE monitors the PDCCH for the FR2 cell on the FR1 cell or on the FR2 cell, depending on the cross/multi-carrier scheduling or the self-scheduling, may depend on the DRX state (e.g., on or off) of the FR2 cell and/or the FR1 cell, and may not depend on explicit signaling, which would otherwise increase a signaling overhead.

In some aspects, since the FR2 cell may be scheduled by either the FR1 cell (via cross/multi-carrier scheduling) or the FR2 cell (via self-scheduling), the UE may support a dynamic switch between scheduling cells (or scheduling schemes). The UE may dynamically switch between scheduling the FR2 cell using the FR1 cell or the FR2 cell, where the dynamic switch may involve switching between cross/multi-carrier scheduling and self-scheduling. When the UE monitors the PDCCH for the FR2 cell based at least in part on the DRX state of the FR2 cell and/or the FR1 cell, the scheduling cell/scheme (e.g., FR1 or FR2) may be switched flexibly, which may enable a tradeoff between power savings and flexible scheduling.

FIG. 7 is a diagram illustrating an example 700 associated with performing downlink channel monitoring on cells based at least in part on DRX states, in accordance with the present disclosure. As shown in FIG. 7, example 700 includes communication between a UE (e.g., UE 120) and a network node (e.g., network node 110). In some aspects, the UE and the network node may be included in a wireless network, such as wireless network 100.

As shown by reference number 702, the UE may receive, from the network node, a configuration associated with cell scheduling. The cell scheduling may be a cross/multi-carrier scheduling or a self-scheduling. The UE may be configured, by the network node and via the configuration associated with cell scheduling or via a separate configuration, with dual DRX groups and an FR1-FR2 carrier aggregation. The dual DRX groups may include a first DRX group and a second DRX group. The first DRX group may be associated with a first set of component carriers, and the second DRX group may be associated with a second set of component carriers. The FR1-FR2 carrier aggregation may involve FR1, which may be associated with a first cell, and FR2, which may be associated with a second cell. In other words, the first cell may be an FR1 cell, and the second cell may be an FR2 cell. Alternatively, the UE may be configured with an FR1 and FR1 carrier aggregation, an FR2 and FR2 carrier aggregation, an FR1 and FR3 carrier aggregation, and so on. The first cell may be associated with FR1 and the second cell may be associated with FR1, or the first cell may be associated with FR2 and the second cell may be associated with FR2. The first DRX group may be an FR1 DRX group, and the second DRX group may be an FR2 DRX group.

As shown by reference number 704, the network node may transmit DCI to the UE. The network node may transmit the DCI based at least in part on the configuration associated with cell scheduling. The DCI may be associated with a cell scheduling for the second cell. The cell scheduling for the second cell may involve the cross/multi-carrier scheduling or the self-scheduling. The network node may transmit the DCI using a component carrier associated with the first DRX group or a component carrier associated with the second DRX group, depending on which of the first DRX group or the second DRX group is active at the time the DCI is transmitted to the UE.

As shown by reference number 706, the UE may perform, based at least in part on the configuration and for a cell scheduling of the second cell, a PDCCH monitoring on the first cell or on the second cell based at least in part on a DRX state of the first DRX group associated with the first cell or a DRX state of the second DRX group associated with the second cell. The UE may perform the PDCCH monitoring for the second cell on the first cell for the cross/multi-carrier scheduling, or the UE may perform the PDCCH monitoring for the second cell on the second cell for the self-scheduling. The second cell may be a scheduled cell. For example, the second cell may be an FR2 scheduled cell. The first cell may be a scheduling cell for the cross/multi-carrier scheduling. For example, the first cell may be an FR1 scheduling cell. Alternatively, the second cell may be a scheduling cell for the self-scheduling. For example, the second cell may be both an FR2 scheduling cell and the FR2 scheduled cell in the case of self-scheduling.

In some aspects, the UE may be configured with the dual DRX groups for the FR1-FR2 carrier aggregation. For the FR2 scheduled cell, the UE may monitor the PDCCH on the FR1 cell for cross/multi-carrier scheduling, or on the FR2 scheduled cell for self-scheduling, based at least in part on DRX state(s) of the FR1 DRX group and/or the FR2 DRX group. When the FR2 DRX group is off, the UE may monitor the PDCCH for the FR2 scheduled cell on the FR1 cell for cross/multi-carrier scheduling. When the FR2 DRX group is on, the UE may monitor the PDCCH for the FR2 scheduled cell on the FR2 scheduled cell for self-scheduling.

In some aspects, the UE may be configured with, for the scheduled cell (e.g., the second cell, the FR2 cell, or the FR2 scheduled cell), one or more candidate scheduling cells for switching. The one or more candidate scheduling cells may be associated with either the first cell or the second cell. Further, up to one candidate scheduling cell per DRX group may be configured for the scheduled cell. In other words, the UE may be configured with, for each scheduled cell, one or multiple candidate scheduling cells (e.g., two candidate scheduling cells) for switching, and for each scheduled cell, the UE may be configured with up to one candidate scheduling cell per DRX group.

In some aspects, the UE may select, for the scheduled cell, a scheduling cell from the one or more candidate scheduling cells. The UE may select, for the scheduled cell, a scheduling mode (e.g., cross/multi-carrier scheduling versus self-scheduling). The UE may select, for the scheduled cell, the scheduling cell and the scheduling mode based at least in part on the DRX state of the first DRX group and/or the DRX state of the second DRX group. The DRX state of the first DRX group may be an on state or an off state. The DRX state of the second DRX group may be an on state or an off state.

In some aspects, the UE may determine, at a given time and for the scheduled cell, whether one or more of the first DRX group or the second DRX group are active. At the given time, the first DRX group and/or the second DRX group may be active during a DRX active time. Alternatively, at the given time, the first DRX group and/or the second DRX group may be inactive during a DRX inactive time. The first DRX group and/or the second DRX group may be associated with a candidate scheduling cell of the one or more candidate scheduling cells.

In some aspects, the UE may determine, at the given time and for the scheduled cell, that the first DRX group or the second DRX group is active. In this case, the UE may perform the PDCCH monitoring for the scheduled cell using the candidate scheduling cell associated with the first DRX group or the second DRX group that is active. In some aspects, the UE may determine, at the given time and for the scheduled cell, that both the first DRX group and the second DRX group are active. In this case, the UE may perform the PDCCH monitoring for the scheduled cell using the candidate scheduling cell associated with the first DRX group or the second DRX group, which may be based at least in part on an RRC configuration received from the network node or on a predefined rule. The predefined rule may be based at least in part on a cell index, a frequency range index, or a band index. In other words, when both the first DRX group and the second DRX group are active, the UE may select which of the first DRX group or the second DRX is to perform the PDCCH monitoring, and the selection may be based at least in part on the RRC configuration or the predefined rule.

In some aspects, for the scheduled cell, the UE may determine the scheduling cell and a scheduling scheme (e.g., cross/multi-carrier scheduling versus self-scheduling) based at least in part on on/off states of the DRX groups. For the scheduled cell, at a time, the UE may check which DRX group having a candidate scheduling cell is active. When only one DRX group having a candidate scheduling cell is active (e.g., only one of the first DRX group or the second DRX group is active), the UE may monitor the PDCCH for the scheduled cell on the scheduling cell. For example, when only the first DRX group is active and the first DRX group is associated with a scheduling cell, the UE may monitor the PDCCH on the scheduling cell associated with the first DRX group. As another example, when only the second DRX group is active and the second DRX group is associated with a scheduling cell, the UE may monitor the PDCCH on the scheduling cell associated with the second DRX group. When multiple DRX groups having candidate scheduling cells are active (e.g., both the first DRX group and the second DRX group are active, and both the first DRX group and the second DRX group are associated with a candidate scheduling cell), the UE may monitor the PDCCH for the scheduled cell on one of the candidate scheduling cells associated with the first DRX group or the second DRX group. The UE may select the candidate scheduling cell, which may be associated with either the first DRX group or the second DRX group, based at least in part on the predefined rule or the RRC configuration. The predefined rule may be based at least in part on the cell index, the frequency range index (e.g., FR1 versus FR2), and/or the band index.

In some aspects, when no candidate scheduling cell is associated with an active DRX group (e.g., the first DRX group and/or the second DRX group are active but are not associated with any candidate scheduling cells), the UE may not monitor the PDCCH for the scheduled cell on any candidate scheduling cell.

In some aspects, the UE may successfully receive and decode the DCI based at least in part on the PDCCH monitoring. The DCI may be associated with the cell scheduling for the second cell. The cell scheduling for the second cell may involve the cross/multi-carrier scheduling or the self-scheduling.

As indicated above, FIG. 7 is provided as an example. Other examples may differ from what is described with regard to FIG. 7.

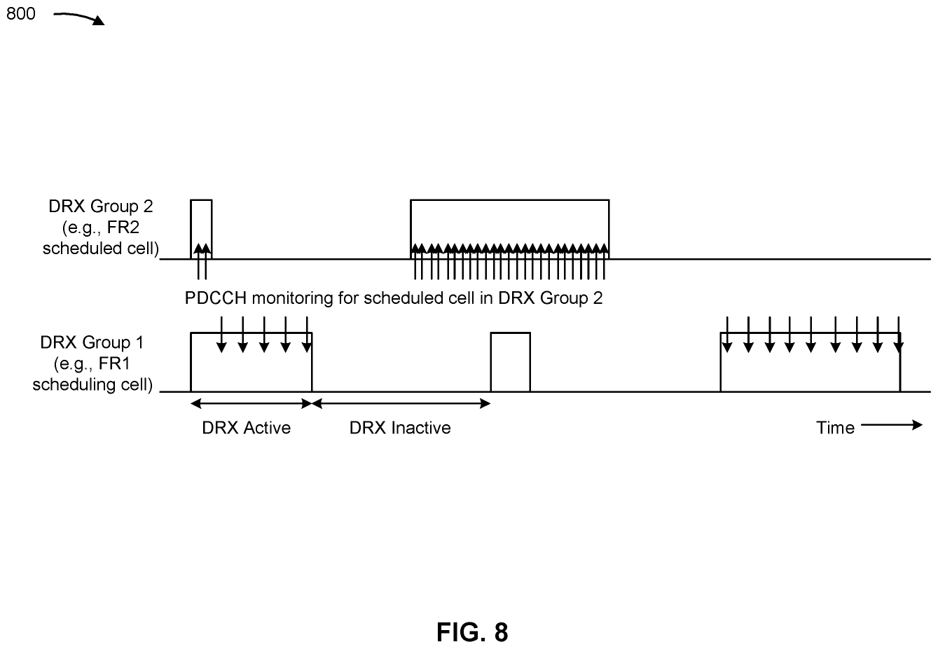

FIG. 8 is a diagram illustrating an example 800 associated with performing downlink channel monitoring on cells based at least in part on DRX states, in accordance with the present disclosure.

As shown in FIG. 8, a first DRX group may be associated with an FR1 scheduling cell, and a second DRX group may be associated with an FR2 scheduled cell. At a given time, a UE may perform a PDCCH monitoring for the FR2 scheduled cell, where the UE may perform the PDCCH monitoring in either the first DRX group or the second DRX group. The UE may perform the PDCCH monitoring based at least in part on DRX states associated with the first DRX group and/or the second DRX group, where “DRX state” may refer to a DRX active state or a DRX inactive state. During a time period in which both the first DRX group and the second DRX group are associated with DRX active, the UE may perform the PDCCH monitoring for the FR2 scheduled cell on the FR2 scheduled cell (for self-scheduling). During a time period in which only the first DRX group is associated with DRX active, the UE may perform the PDCCH monitoring for the FR2 scheduled cell on the FR1 scheduling cell (for cross/multi-carrier scheduling). During a time period in which both the first DRX group and the second DRX group are associated with DRX inactive, the UE may not perform any PDCCH monitoring for the FR2 scheduled cell. During a time period in which only the second DRX group is associated with DRX active, the UE may perform the PDCCH monitoring for the FR2 scheduled cell on the FR2 scheduled cell (for self-scheduling).

In some aspects, for the FR2 scheduled cell, when a scheduling PDCCH is monitored on the FR2 scheduled cell itself, a scheduling may be self-scheduling. For the FR2 scheduled cell, when the scheduling PDCCH is monitored on a non-scheduled cell (e.g., the FR1 scheduling cell), the scheduling may be cross/multi-carrier scheduling.

As indicated above, FIG. 8 is provided as an example. Other examples may differ from what is described with regard to FIG. 8.

FIG. 9 is a diagram illustrating an example process 900 performed, for example, by a UE, in accordance with the present disclosure. Example process 900 is an example where the UE (e.g., UE 120) performs operations associated with performing downlink channel monitoring on cells based at least in part on DRX states.

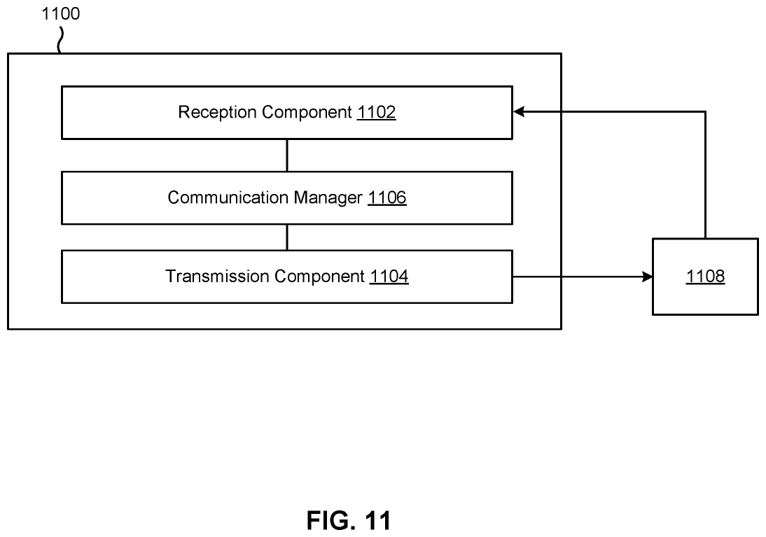

As shown in FIG. 9, in some aspects, process 900 may include receiving, from a network node, a configuration associated with cell scheduling (block 910). For example, the UE (e.g., using reception component 1102 and/or communication manager 1106, depicted in FIG. 11) may receive, from a network node, a configuration associated with cell scheduling, as described above.

As further shown in FIG. 9, in some aspects, process 900 may include performing and based at least in part on the configuration and for a cell scheduling of a second cell, a PDCCH monitoring on a first cell or on the second cell being based at least in part on one or more of a DRX state of a first DRX group associated with the first cell or a DRX state of a second DRX group associated with the second cell (block 920). For example, the UE (e.g., using communication manager 1106, depicted in FIG. 11) may perform and based at least in part on the configuration and for a cell scheduling of a second cell, a PDCCH monitoring on a first cell or on the second cell being based at least in part on one or more of a DRX state of a first DRX group associated with the first cell or a DRX state of a second DRX group associated with the second cell, as described above.

Process 900 may include additional aspects, such as any single aspect or any combination of aspects described below and/or in connection with one or more other processes described elsewhere herein.

In a first aspect, the first cell is associated with an FR1 and the second cell is associated with an FR2.

In a second aspect, alone or in combination with the first aspect, the UE is configured with an FR1 and FR2 carrier aggregation, and the UE is configured with the first DRX group and the second DRX group.

In a third aspect, alone or in combination with one or more of the first and second aspects, process 900 includes performing the PDCCH monitoring for the second cell on the first cell for a cross-carrier scheduling or a multi-carrier scheduling.

In a fourth aspect, alone or in combination with one or more of the first through third aspects, process 900 includes performing the PDCCH monitoring for the second cell on the second cell for a self-scheduling.

In a fifth aspect, alone or in combination with one or more of the first through fourth aspects, the second cell is a scheduled cell, and the first cell is a scheduling cell for a cross-carrier scheduling or a multi-carrier scheduling, or the second cell is a scheduling cell for a self-scheduling.

In a sixth aspect, alone or in combination with one or more of the first through fifth aspects, the UE is configured with, for the scheduled cell, one or more candidate scheduling cells for switching, and up to one candidate scheduling cell per DRX group is configured for the scheduled cell.

In a seventh aspect, alone or in combination with one or more of the first through sixth aspects, process 900 includes selecting, for the scheduled cell, a scheduling cell and a scheduling mode based at least in part on one or more of the DRX state of the first DRX group and the DRX state of the second DRX group, wherein the scheduling mode is one of a cross-carrier scheduling or multi-carrier scheduling mode or a self-scheduling mode.

In an eighth aspect, alone or in combination with one or more of the first through seventh aspects, process 900 includes determining, at a given time and for the scheduled cell, whether one or more of the first DRX group or the second DRX group are active, wherein one or more of the first DRX group or the second DRX group are associated with a candidate scheduling cell of the one or more candidate scheduling cells.

In a ninth aspect, alone or in combination with one or more of the first through eighth aspects, process 900 includes determining, at the given time and for the scheduled cell, that one of the first DRX group or the second DRX group is active, and performing the PDCCH monitoring for the scheduled cell using the candidate scheduling cell associated with the first DRX group or the second DRX group that is active.

In a tenth aspect, alone or in combination with one or more of the first through ninth aspects, process 900 includes determining, at the given time and for the scheduled cell, that both the first DRX group and the second DRX group are active, and performing the PDCCH monitoring for the scheduled cell using the candidate scheduling cell associated with the first DRX group or the second DRX group based at least in part on an RRC configuration received from the network node or on a predefined rule.

In an eleventh aspect, alone or in combination with one or more of the first through tenth aspects, the predefined rule is based at least in part on a cell index, a frequency range index, or a band index.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a network node, in accordance with the present disclosure. Example process 1000 is an example where the network node (e.g., network node 110) performs operations associated with performing downlink channel monitoring on cells based at least in part on DRX states.

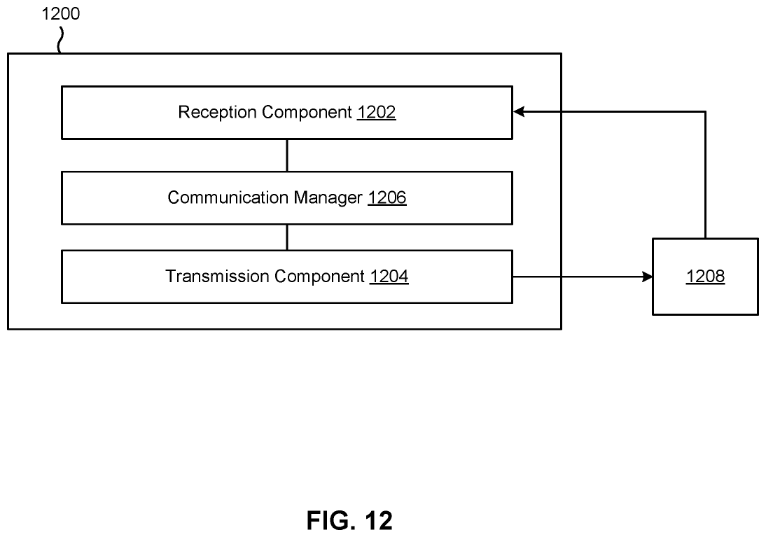

As shown in FIG. 10, in some aspects, process 1000 may include transmitting, to a UE, a configuration associated with cell scheduling (block 1010). For example, the network node (e.g., using transmission component 1204 and/or communication manager 1206, depicted in FIG. 12) may transmit, to a UE, a configuration associated with cell scheduling, as described above.

As further shown in FIG. 10, in some aspects, process 1000 may include transmitting, to the UE and based at least in part on the configuration, DCI associated with a cell scheduling for a second cell, a PDCCH monitoring on a first cell or on the second cell being based at least in part on one or more of a DRX state of a first DRX group associated with the first cell or a DRX state of a second DRX group associated with the second cell (block 1020). For example, the network node (e.g., using transmission component 1204 and/or communication manager 1206, depicted in FIG. 12) may transmit, to the UE and based at least in part on the configuration, DCI associated with a cell scheduling for a second cell, a PDCCH monitoring on a first cell or on the second cell being based at least in part on one or more of a DRX state of a first DRX group associated with the first cell or a DRX state of a second DRX group associated with the second cell, as described above.

Process 1000 may include additional aspects, such as any single aspect or any combination of aspects described below and/or in connection with one or more other processes described elsewhere herein.

In a first aspect, the first cell is associated with an FR1 and the second cell is associated with an FR2.

In a second aspect, alone or in combination with the first aspect, process 1000 includes configuring the UE with an FR1 and FR2 carrier aggregation, and configuring the UE with the first DRX group and the second DRX group.

In a third aspect, alone or in combination with one or more of the first and second aspects, the PDCCH monitoring for the second cell on the first cell is for a cross-carrier scheduling or a multi-carrier scheduling.

In a fourth aspect, alone or in combination with one or more of the first through third aspects, the PDCCH monitoring for the second cell on the second cell is for a self-scheduling.

In a fifth aspect, alone or in combination with one or more of the first through fourth aspects, the second cell is a scheduled cell, and the first cell is a scheduling cell for a cross-carrier scheduling or a multi-carrier scheduling, or the second cell is a scheduling cell for a self-scheduling.

In a sixth aspect, alone or in combination with one or more of the first through fifth aspects, for the scheduled cell, one or more candidate scheduling cells are configured for switching, and up to one candidate scheduling cell per DRX group is configured for the scheduled cell.

In a seventh aspect, alone or in combination with one or more of the first through sixth aspects, for the scheduled cell, a scheduling cell and a scheduling mode based at least in part on one or more of the DRX state of the first DRX group and the DRX state of the second DRX group, wherein the scheduling mode is one of a cross-carrier scheduling or multi-carrier scheduling mode or a self-scheduling mode.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 140 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 7-8. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive, from a network node, a configuration associated with cell scheduling. The communication manager 1106 may 1106 may perform and based at least in part on the configuration and for a cell scheduling of a second cell, a PDCCH monitoring on a first cell or on the second cell being based at least in part on one or more of a DRX state of a first DRX group associated with the first cell or a DRX state of a second DRX group associated with the second cell.

The communication manager 1106 may perform the PDCCH monitoring for the second cell on the first cell for a cross-carrier scheduling or a multi-carrier scheduling. The communication manager 1106 may perform the PDCCH monitoring for the second cell on the second cell for a self-scheduling. The communication manager 1106 may select, for the scheduled cell, a scheduling cell and a scheduling mode based at least in part on one or more of the DRX state of the first DRX group and the DRX state of the second DRX group, wherein the scheduling mode is one of a cross-carrier scheduling or multi-carrier scheduling mode or a self-scheduling mode. The communication manager 1106 may determine, at a given time and for the scheduled cell, whether one or more of the first DRX group or the second DRX group are active, wherein one or more of the first DRX group or the second DRX group are associated with a candidate scheduling cell of the one or more candidate scheduling cells.

The communication manager 1106 may determine, at the given time and for the scheduled cell, that one of the first DRX group or the second DRX group is active. The communication manager 1106 may perform the PDCCH monitoring for the scheduled cell using the candidate scheduling cell associated with the first DRX group or the second DRX group that is active. The communication manager 1106 may determine, at the given time and for the scheduled cell, that both the first DRX group and the second DRX group are active. The communication manager 1106 may perform the PDCCH monitoring for the scheduled cell using the candidate scheduling cell associated with the first DRX group or the second DRX group based at least in part on an RRC configuration received from the network node or on a predefined rule.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 7-8. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the network node described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the network node described in connection with FIG. 2. In some aspects, the reception component 1202 and/or the transmission component 1204 may 1204 may include or may be included in a network interface. The network interface may be configured to obtain and/or output signals for the apparatus 1200 via one or more communications links, such as a backhaul link, a midhaul link, and/or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, a modem, a modulator, a transmit MIMO processor, a transmit processor, a controller/processor, a memory, or a combination thereof, of the network node described in connection with FIG. 2. In some aspects, the transmission component 1204 may be co-located with the reception component 1202 in a transceiver.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The transmission component 1204 may transmit, to a UE, a configuration associated with cell scheduling. The transmission component 1204 may transmit, to the UE and based at least in part on the configuration, DCI associated with a cell scheduling for a second cell, a PDCCH monitoring on a first cell or on the second cell being based at least in part on one or more of a DRX state of a first DRX group associated with the first cell or a DRX state of a second DRX group associated with the second cell.

The communication manager 1206 may configure the UE with an FR1 and FR2 carrier aggregation. The communication manager 1206 may configure the UE with the first DRX group and the second DRX group.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

Aspect 1: A method of wireless communication performed by a user equipment (UE), comprising: receiving, by the UE and from a network node, a configuration associated with cell scheduling; and performing, by the UE, and based at least in part on the configuration and for a cell scheduling of a second cell, a physical downlink control channel (PDCCH) monitoring on a first cell or on the second cell based at least in part on one or more of a discontinuous reception (DRX) state of a first DRX group associated with the first cell or a DRX state of a second DRX group associated with the second cell.

Aspect 2: The method of Aspect 1, wherein the first cell is associated with a first frequency range (FR1) and the second cell is associated with a second frequency range (FR2).

Aspect 3: The method of Aspect 2, wherein the UE is configured with an FR1 and FR2 carrier aggregation, and wherein the UE is configured with the first DRX group and the second DRX group.

Aspect 4: The method of any of Aspects 1-3, wherein performing the PDCCH monitoring comprises: performing the PDCCH monitoring for the second cell on the first cell for a cross-carrier scheduling or a multi-carrier scheduling.

Aspect 5: The method of any of Aspects 1-4, wherein performing the PDCCH monitoring comprises: performing the PDCCH monitoring for the second cell on the second cell for a self-scheduling.

Aspect 6: The method of any of Aspects 1-5, wherein the second cell is a scheduled cell, and wherein the first cell is a scheduling cell for a cross-carrier scheduling or a multi-carrier scheduling, or the second cell is a scheduling cell for a self-scheduling.

Aspect 7: The method of Aspect 6, wherein the UE is configured with, for the scheduled cell, one or more candidate scheduling cells for switching, and wherein up to one candidate scheduling cell per DRX group is configured for the scheduled cell.

Aspect 8: The method of Aspect 7, further comprising: selecting, for the scheduled cell, a scheduling cell and a scheduling mode based at least in part on one or more of the DRX state of the first DRX group and the DRX state of the second DRX group, wherein the scheduling mode is one of a cross-carrier scheduling or multi-carrier scheduling mode or a self-scheduling mode.

Aspect 9: The method of Aspect 8, further comprising: determining, at a given time and for the scheduled cell, whether one or more of the first DRX group or the second DRX group are active, wherein one or more of the first DRX group or the second DRX group are associated with a candidate scheduling cell of the one or more candidate scheduling cells.

Aspect 10: The method of Aspect 9, further comprising: determining, at the given time and for the scheduled cell, that one of the first DRX group or the second DRX group is active; and performing the PDCCH monitoring for the scheduled cell using the candidate scheduling cell associated with the first DRX group or the second DRX group that is active.

Aspect 11: The method of Aspect 9, further comprising: determining, at the given time and for the scheduled cell, that both the first DRX group and the second DRX group are active; and performing the PDCCH monitoring for the scheduled cell using the candidate scheduling cell associated with the first DRX group or the second DRX group based at least in part on a radio resource control (RRC) configuration received from the network node or on a predefined rule.

Aspect 12: The method of Aspect 11, wherein the predefined rule is based at least in part on a cell index, a frequency range index, or a band index.

Aspect 13: A method of wireless communication performed by a network node, comprising: transmitting, by the network node and to a user equipment (UE), a configuration associated with cell scheduling; and transmitting, by the network node and to the UE and based at least in part on the configuration, downlink control information (DCI) associated with a cell scheduling for a second cell, a physical downlink control channel (PDCCH) monitoring on a first cell or on the second cell being based at least in part on one or more of a discontinuous reception (DRX) state of a first DRX group associated with the first cell or a second DRX group associated with the second cell.

Aspect 14: The method of Aspect 13, wherein the first cell is associated with a first frequency range (FR1) and the second cell is associated with a second frequency range (FR2).

Aspect 15: The method of Aspect 14, further comprising: configuring the UE with an FR1 and FR2 carrier aggregation; and configuring the UE with the first DRX group and the second DRX group.

Aspect 16: An apparatus for wireless communication at a device, comprising a processor; memory coupled with the processor; and instructions stored in the memory and executable by the processor to cause the apparatus to perform the method of one or more of Aspects 1-12.

Aspect 17: A device for wireless communication, comprising a memory and one or more processors coupled to the memory, the one or more processors configured to perform the method of one or more of Aspects 1-12.

Aspect 18: An apparatus for wireless communication, comprising at least one means for performing the method of one or more of Aspects 1-12.

Aspect 19: A non-transitory computer-readable medium storing code for wireless communication, the code comprising instructions executable by a processor to perform the method of one or more of Aspects 1-12.

Aspect 20: A non-transitory computer-readable medium storing a set of instructions for wireless communication, the set of instructions comprising one or more instructions that, when executed by one or more processors of a device, cause the device to perform the method of one or more of Aspects 1-12.

Aspect 21: An apparatus for wireless communication at a device, comprising a processor; memory coupled with the processor; and instructions stored in the memory and executable by the processor to cause the apparatus to perform the method of one or more of Aspects 13-15.

Aspect 22: A device for wireless communication, comprising a memory and one or more processors coupled to the memory, the one or more processors configured to perform the method of one or more of Aspects 13-15.

Aspect 23: An apparatus for wireless communication, comprising at least one means for performing the method of one or more of Aspects 13-15.

Aspect 24: A non-transitory computer-readable medium storing code for wireless communication, the code comprising instructions executable by a processor to perform the method of one or more of Aspects 13-15.

Aspect 25: A non-transitory computer-readable medium storing a set of instructions for wireless communication, the set of instructions comprising one or more instructions that, when executed by one or more processors of a device, cause the device to perform the method of one or more of Aspects 13-15.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, that, based at least in part on information stored in the memory, are configured to:
receive, from a network node, a configuration associated with cell scheduling; and
perform, based at least in part on the configuration and for a cell scheduling of a second cell, a physical downlink control channel (PDCCH) monitoring on a first cell or on the second cell based at least in part on one or more of a discontinuous reception (DRX) state of a first DRX group associated with the first cell or a DRX state of a second DRX group associated with the second cell.

2. The apparatus of claim 1, wherein the first cell is associated with a first frequency range (FR1) and the second cell is associated with a second frequency range (FR2).

3. The apparatus of claim 2, wherein the UE is configured with an FR1 and FR2 carrier aggregation, and wherein the UE is configured with the first DRX group and the second DRX group.

4. The apparatus of claim 1, wherein the one or more processors, that are configured to perform the PDCCH monitoring, based at least in part on the information stored in the memory, are configured to:
perform the PDCCH monitoring for the second cell on the first cell for a cross-carrier scheduling or a multi-carrier scheduling.

5. The apparatus of claim 1, wherein the one or more processors, that are configured to perform the PDCCH monitoring, based at least in part on the information stored in the memory, are configured to:
perform the PDCCH monitoring for the second cell on the second cell for a self-scheduling.

6. The apparatus of claim 1, wherein the second cell is a scheduled cell, and wherein the first cell is a scheduling cell for a cross-carrier scheduling or a multi-carrier scheduling, or the second cell is a scheduling cell for a self-scheduling.

7. The apparatus of claim 6, wherein the UE is configured with, for the scheduled cell, one or more candidate scheduling cells for switching, and wherein up to one candidate scheduling cell per DRX group is configured for the scheduled cell.

8. The apparatus of claim 7, wherein the one or more processors, based at least in part on the information stored in the memory, are further configured to:
select, for the scheduled cell, a scheduling cell and a scheduling mode based at least in part on one or more of the DRX state of the first DRX group and the DRX state of the second DRX group, wherein the scheduling mode is one of a cross-carrier scheduling or multi-carrier scheduling mode or a self-scheduling mode.

9. The apparatus of claim 8, wherein the one or more processors, based at least in part on the information stored in the memory, are further configured to:
determine, at a given time and for the scheduled cell, whether one or more of the first DRX group or the second DRX group are active, wherein one or more of the first DRX group or the second DRX group are associated with a candidate scheduling cell of the one or more candidate scheduling cells.

10. The apparatus of claim 9, wherein the one or more processors, based at least in part on the information stored in the memory, are further configured to:
determine, at the given time and for the scheduled cell, that one of the first DRX group or the second DRX group is active; and
perform the PDCCH monitoring for the scheduled cell using the candidate scheduling cell associated with the first DRX group or the second DRX group that is active.

11. The apparatus of claim 9, wherein the one or more processors, based at least in part on the information stored in the memory, are further configured to:
determine, at the given time and for the scheduled cell, that both the first DRX group and the second DRX group are active; and
perform the PDCCH monitoring for the scheduled cell using the candidate scheduling cell associated with the first DRX group or the second DRX group based at least in part on a radio resource control (RRC) configuration received from the network node or on a predefined rule.

12. The apparatus of claim 11, wherein the predefined rule is based at least in part on a cell index, a frequency range index, or a band index.

13. An apparatus for wireless communication at a network node, comprising:
a memory; and
one or more processors, coupled to the memory, that, based at least in part on information stored in the memory, are configured to:
transmit, to a user equipment (UE), a configuration associated with cell scheduling; and
transmit, to the UE and based at least in part on the configuration, downlink control information (DCI) associated with a cell scheduling for a second cell, a physical downlink control channel (PDCCH) monitoring on a first cell or on the second cell being based at least in part on one or more of a discontinuous reception (DRX) state of a first DRX group associated with the first cell or a second DRX group associated with the second cell.

14. The apparatus of claim 13, wherein the first cell is associated with a first frequency range (FR1) and the second cell is associated with a second frequency range (FR2).

15. The apparatus of claim 14, wherein the one or more processors, based at least in part on the information stored in the memory, are further configured to:
configure the UE is with an FR1 and FR2 carrier aggregation; and
configure the UE with the first DRX group and the second DRX group.

16. A method of wireless communication performed by a user equipment (UE), comprising:
receiving, by the UE and from a network node, a configuration associated with cell scheduling; and
performing, by the UE, and based at least in part on the configuration and for a cell scheduling of a second cell, a physical downlink control channel (PDCCH) monitoring on a first cell or on the second cell based at least in part on one or more of a discontinuous reception (DRX) state of a first DRX group associated with the first cell or a DRX state of a second DRX group associated with the second cell.

17. The method of claim 16, wherein the first cell is associated with a first frequency range (FR1) and the second cell is associated with a second frequency range (FR2).

18. The method of claim 17, wherein the UE is configured with an FR1 and FR2 carrier aggregation, and wherein the UE is configured with the first DRX group and the second DRX group.

19. The method of claim 16, wherein performing the PDCCH monitoring comprises:
performing the PDCCH monitoring for the second cell on the first cell for a cross-carrier scheduling or a multi-carrier scheduling.

20. The method of claim 16, wherein performing the PDCCH monitoring comprises:
performing the PDCCH monitoring for the second cell on the second cell for a self-scheduling.

21. The method of claim 16, wherein the second cell is a scheduled cell, and wherein the first cell is a scheduling cell for a cross-carrier scheduling or a multi-carrier scheduling, or the second cell is a scheduling cell for a self-scheduling.

22. The method of claim 21, wherein the UE is configured with, for the scheduled cell, one or more candidate scheduling cells for switching, and wherein up to one candidate scheduling cell per DRX group is configured for the scheduled cell.

23. The method of claim 22, further comprising:
selecting, for the scheduled cell, a scheduling cell and a scheduling mode based at least in part on one or more of the DRX state of the first DRX group and the DRX state of the second DRX group, wherein the scheduling mode is one of a cross-carrier scheduling or multi-carrier scheduling mode or a self-scheduling mode.

24. The method of claim 23, further comprising:
determining, at a given time and for the scheduled cell, whether one or more of the first DRX group or the second DRX group are active, wherein one or more of the first DRX group or the second DRX group are associated with a candidate scheduling cell of the one or more candidate scheduling cells.

25. The method of claim 24, further comprising:
determining, at the given time and for the scheduled cell, that one of the first DRX group or the second DRX group is active; and
performing the PDCCH monitoring for the scheduled cell using the candidate scheduling cell associated with the first DRX group or the second DRX group that is active.

26. The method of claim 24, further comprising:
determining, at the given time and for the scheduled cell, that both the first DRX group and the second DRX group are active; and
performing the PDCCH monitoring for the scheduled cell using the candidate scheduling cell associated with the first DRX group or the second DRX group based at least in part on a radio resource control (RRC) configuration received from the network node or on a predefined rule.

27. The method of claim 26, wherein the predefined rule is based at least in part on a cell index, a frequency range index, or a band index.

28. A method of wireless communication performed by a network node, comprising:
transmitting, by the network node and to a user equipment (UE), a configuration associated with cell scheduling; and
transmitting, by the network node and to the UE and based at least in part on the configuration, downlink control information (DCI) associated with a cell scheduling for a second cell, a physical downlink control channel (PDCCH) monitoring on a first cell or on the second cell being based at least in part on one or more of a discontinuous reception (DRX) state of a first DRX group associated with the first cell or a second DRX group associated with the second cell.

29. The method of claim 28, wherein the first cell is associated with a first frequency range (FR1) and the second cell is associated with a second frequency range (FR2).

30. The method of claim 29, further comprising:
configuring the UE with an FR1 and FR2 carrier aggregation; and
configuring the UE with the first DRX group and the second DRX group.
